(19) United States
(12) Patent Application Publication
(10) Pub. No.: US 2015/0307265 A1
(43) Pub. Date: Oct. 29, 2015

(54) WATER BOTTLE WITH STRAW HAVING INTEGRATED FILTER AND DOWNSTREAM FLAVOR TABLET

(71) Applicant: TRIMR, LLC, SALT LAKE CITY, UT (US)

(72) Inventors: Travis J. Winn, Salt Lake City, UT (US); Gary C. Moore, Salt Lake City, UT (US)

(21) Appl. No.: 14/695,351

(22) Filed: Apr. 24, 2015

Related U.S. Application Data
(60) Provisional application No. 61/983,631, filed on Apr. 24, 2014.

(51) Int. Cl. B65D 85/804; A23L 2/38; C02F 1/00; A23L 2/56

(52) U.S. Cl. CPC B65D 85/804; A23L 2/56; A23L 2/38; C02F 1/002; A23V 2002/00; C02F 2307/02

(57) ABSTRACT

Water bottles and flavor tablets for use therewith. The water bottle includes a container having a closed end, an open end, and a removable lid selectively coupleable over the open end of the container. A straw is disposed through the lid, or attached to the lid. A filter may be disposed within the straw, the filter removing impurities from water as it is drawn from the chamber through an opening within the straw, through the filter. A flavor tablet (e.g., a dissolvable solid including a flow channel disposed therein, or defined between a perimeter edge of the tablet and the straw or spout) can be placed within the straw or spout of the water bottle, downstream from (e.g., above) the filter so that water drawn through the straw passes first through the filter (if present), and then around or through the flavor tablet, flavoring the water drawn therethrough.

### CROSS-REFERENCE TO RELATED APPLICATIONS

The present application claims the benefit of U.S. Patent Application No. 61/983,631, filed Apr. 24, 2014, the disclosure of which is herein incorporated by reference in its entirety.

### BACKGROUND OF THE INVENTION

1. The Field of the Invention

The present invention is in the field of containers (e.g., water bottles) used for holding and providing personal use quantities of a beverage.

2. The Relevant Technology

Reusable personal water bottles are widely used by many trying to maintain or increase their daily intake of water.

Despite the recently available variety of such water bottles, there remains a need for further improved water bottles providing additional functionality.

### BRIEF SUMMARY

Although there exist novelty straws (e.g., U.S. Pat. No. 8,334,003) into which flavoring granules may be placed, such systems are messy, due to the presence of the large quantity of individual, loose flavoring granules provided therein. It would be advantageous to provide a simpler, less messy system that would allow a user to flavor water dispensed from a personal water bottle.

Furthermore, available water bottles including filter systems are not particularly selective in their removal of components within the water. Such existing systems simply remove all particulates greater than a given size, and also remove other components that are chemically adsorbed or otherwise trapped by the filter media. Such systems are not sophisticated about removing only unwanted “bad” contaminants from the water. For example, the current filters do not discriminate between minerals or other components in the water that are good or bad for the user, but rather simply stop any and all materials can be stopped by the particular filtration mechanism.

The present invention solves this problem by providing the ability to add good or desirable components to the water (e.g., back into the water) flow after water may be filtered, by whatever filtration technique desired. In this way, the user can ensure they are both filtering out the bad, while still receiving the good. This is accomplished by using a dissolvable tablet that is downstream from any filtering system, which tablet allows the user to introduce or reintroduce good, desired minerals, vitamins, or flavors into the water after it has filtered out the contaminants in the water.

The present invention relates to reusable water bottles for personal use, and which provide the ability to introduce a flavor or other adjuvant (e.g., vitamins, minerals, etc.) into the drinking water being dispensed from the water bottle, as it is being consumed (e.g., sucked through a straw). According to one embodiment, a water bottle includes a container having a closed end (e.g., bottom) and open end (e.g., top), the container defining a chamber therein for containing water. A removable lid may be included, which lid may be selectively coupleable over the open end (e.g., top) of the container. A straw may be provided, disposed through the removable lid, and/or attached to the lid (e.g., to an underside of the removable lid). The straw may extend towards the closed end (e.g., bottom) of the container. A filter may be disposed within the straw. Such a filter may remove impurities (e.g., chlorine) from water as it is drawn from the chamber through an opening within the straw (e.g., in the bottom of the straw), through the filter. A flavor tablet (e.g., solid and dissolvable) may be provided, disposed within the straw at a location that is downstream from (e.g., above) the filter, so that water drawn into the straw is pulled through the filter, and then around or through the flavor tablet, flavoring the water drawn therethrough.

In an embodiment, the flavor tablet may be positioned within the straw (or spout) at a location above any applicable water line of the container, to prevent premature contact of the tablet with water, and its premature dissolution. For purposes as used herein, a spout (e.g., formed on the removable lid) may be considered to be a portion of the overall straw structure through which the user sucks up the water within the water bottle. The flavor tablet may be a rotatable “flip up” type spout, so that the flavor tablet resides at a “stowed” location that is even further above the water line when not in use, and may rotate downward to a “use” position as the spout is flipped up when the user is ready to drink from the spout. In an embodiment, both the stowed and use positions may be above the water line. In an embodiment, at least the stowed position is above the water line.

Another embodiment is directed to a water bottle including a container having a closed end (e.g., bottom) and open end (e.g., top), the container defining a chamber therein for containing water, a removable lid that is selectively coupleable over the open end (e.g., top) of the container, and a straw disposed through the removable lid, (e.g., a portion of which may be attached to an underside of the removable lid), and the straw may extend towards the closed bottom of the container. A filter may be disposed within the straw, the filter removing impurities (e.g., chlorine, chloramines, etc.) from water as it is drawn from the chamber through an opening at a bottom of the straw, through the filter. A single dissolvable flavor tablet may be disposed within the straw (e.g., above any water line) at a location that is downstream from the filter. The flavor tablet may have a shape that substantially fills a cross-sectional area across the interior of the straw but for one or more channels provided through the flavor tablet or between the flavor tablet and an interior wall of the straw, so that water drawn into the straw is pulled through the filter, and then around or through the flavor tablet, flavoring the water drawn therethrough. Positioning the flavor tablet within the spout, above the water line of the filled container is particularly advantageous.

Another aspect of the present disclosure is directed to a method of flavoring water as it is dispensed from a water bottle, comprising providing a water bottle such as that described above or elsewhere herein, and drawing water contained within the chamber of the water bottle through the straw, so that water is first drawn through the filter, and then around or through the flavor tablet, flavoring the water. By way of example, the flavor tablet may be disposed within the straw (or spout). In an embodiment, the flavor tablet may be disposed at a location above the water line, for example, above the open top of the container.

Another aspect of the present disclosure is directed to a flavor tablet for use in flavoring water within a water bottle such as that described above. Such a flavor tablet may include a dissolvable tablet body which at least partially defines one or more hollow flow channels. For example, a flow channel may be formed through the flavor tablet itself, and/or a flow channel may be defined between a perimeter exterior surface of the tablet body and an interior surface of the straw into which the flavor tablet is positioned during use. The tablet body may be formed of a dissolvable solid material that dissolves as water is drawn through the one or more hollow flow channels when the flavor tablet is disposed within the straw (or spout), above the filter, so that water drawn into the straw is pulled through the filter and then around or through the flavor tablet, flavoring the water drawn therethrough. Such flavor tablets may be sold or otherwise provided separately from the water bottle, as refills. For example, a packet of such flavor tablets may include a plurality of the tablets, packaged together with instructions for their use with the separately provided water bottle.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings, in which:

FIG. 1A is an elevation view of an exemplary water bottle according to an embodiment of the invention, with the spout in a stowed position;

FIG. 1AA is a cross-sectional view through the water bottle of FIG. 1A;

FIG. 1B is an elevation view of an exemplary water bottle according to an embodiment of the invention, with the spout in a flipped up drinking position;

FIG. 1BB is a cross-sectional view through the water bottle of FIG. 1B;

FIG. 1C is an elevation view of an exemplary water bottle according to an embodiment of the invention, with the spout rotated even further downward than the position of FIG. 1A, to a tablet loading position in which a flavor tablet can be inserted into open end of the spout;

FIG. 1CC is a cross-sectional view through the water bottle of FIG. 1C;

FIG. 2A-2B are different elevational views for another water bottle according to the present invention;

FIG. 2C is a cross-sectional view through the water bottle of FIGS. 2A-2B;

FIGS. 3A-3B are cross-sectional views showing placement and/or removal of an exemplary flavor tablet within a straw of a water bottle according to the present invention;

FIGS. 4-5 are cross-sectional views showing alternative coupling mechanisms between straw sections of a multi-part straw of a water bottle according to the present invention;

FIGS. 6A-17C show top views, elevational views, and cross-sectional views of various other shaped flavor tablets according to the present invention;

FIG. 18 is an elevation view of another exemplary water bottle according to the present invention, configured as a squeeze bottle, without a long straw, intended to be inverted and drunk from, and which may include a flavor tablet; and

FIG. 19 is a view of another exemplary water bottle according to the present invention, in which the container is configured as a flexible bladder connected to a tube, allowing the user to drink from the tube, and which may include a flavor tablet.

### DETAILED DESCRIPTION OF THE PREFERRED EMBODIMENTS

### I. Introduction

The present disclosure relates to water bottles and flavor tablets for use therewith. The water bottle may include a container including a closed bottom, an open top, and a removable lid that is selectively coupleable over the open top of the container. A straw may be attached to an underside of the removable lid, the straw extending towards the closed bottom of the container. A filter (e.g., an activated charcoal filter) may be disposed within the straw, the filter removing impurities, odors, undesired tastes, etc. from water as it is drawn from the chamber up through an opening at the bottom of the straw, through the filter. A flavor tablet can be placed within the straw or spout, above (i.e., downstream from) the filter so that water drawn through the straw passes first through the filter, and then through the flavor tablet, flavoring the water drawn therethrough. The flavor tablet may have any of various shapes and includes a flow channel disposed therein, or in conjunction with the straw or spout where placed, defines the flow channel through which the water is pulled (e.g., between the tablet and the inside wall of the straw or spout).

The present disclosure also contemplates providing one or more replacement dissolvable flavor tablets for placement and use within a water bottle, where the tablet is positioned within the straw (or spout), to flavor the water sucked by the user from the water bottle up through the straw. Such a tablet may include one or more hollow channels disposed therein, and/or channels may be defined between the exterior of the tablet and the interior sidewall of the straw or spout. The tablet may be formed of a dissolvable solid material that dissolves as water is drawn through the one or more channels when the flavor tablet is disposed within the straw or spout. Where a filter is also provided within the straw, the flavor tablet may be downstream from the filter. For example, the tablet may be disposed at a location that is above the filter, so that water drawn into the straw is pulled through the filter, and then around or through the flavor tablet, flavoring the water drawn therethrough.

### II. Exemplary Water Bottles

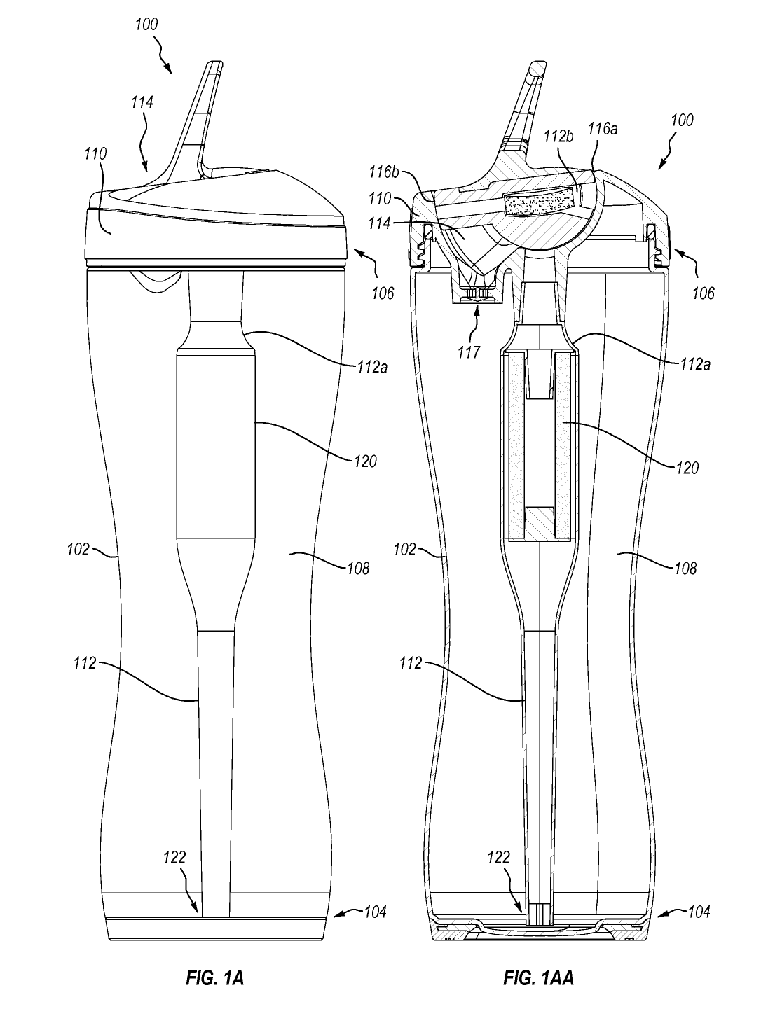

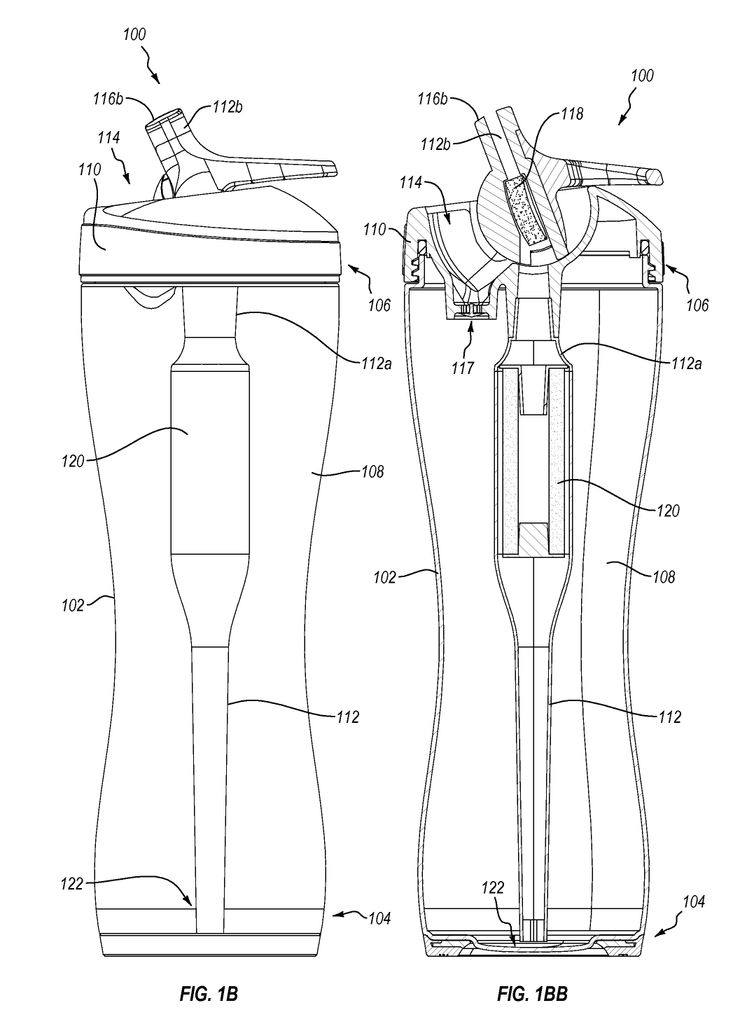

FIGS. 1A-1C, and 1 AA-1CC illustrate an exemplary water bottle 100 according to an embodiment of the present disclosure. For example, the water bottle 100 may include a container 102 having a closed bottom 104 and an open top 106. The container 102 may define a chamber 108 therein for containing water. The water bottle 100 may be sized for convenient, portable use, e.g., it may be sized to hold between about 16 ounces to 50 ounces, or about 500 mL to about 1500 mL of water. For example, in an embodiment, the water bottle may hold from about 16 ounces (473 mL) to about 32 ounces (946 mL) of water (e.g., about 20 ounces (591 mL). The water bottle 100 may include a removable lid 110 that is selectively coupleable over the open top 106 of the container 102. A straw 112 may also be provided, e.g., disposed through the lid 110, attached to an underside of the removable lid 110, etc. In the illustrated embodiment, spout 112b may be considered to be a part of overall straw 112, so that straw 112 may be considered to include a lower portion 112a attached to an underside of lid 110, and a spout portion 112b that extends above the removable lid 110. Spout 112b may be in fluid communication with the lower portion of straw 112a, at least when the user desires to dispense (e.g., suck) water from bottle 110 through straw 112. For example, the fluid communication between spout 112b and straw portion 112a may be selective, as shown in the cross-sectional views of FIGS. 1AA-1CC. For example, spout 112b may be rotatable relative to lid 110, “flipping up” when it is desired to drink water. When not drinking water, the spout may be flipped downward, into a recess 114 formed in removable lid 110.

Container 102, removable lid 110, and straw 112, as well as other components of the water bottle system may be formed from plastic (e.g., injection molded) or another suitable material. In an embodiment, one or more such components may be rigid. In another embodiment, one or more of the components may be flexible (e.g., a squeezable container, a flexible straw, etc.).

FIGS. 1A and 1AA show the spout 112b in the flipped down “stowed” position, where no fluid communication may be provided (see cross-sectional view of FIG. 1AA) between the spout 112b and lower straw portion 112a. The distal dispensing end of the spout may be received within recess 114, in the stowed position, e.g., when not in use. FIGS. 1B and 1BB show the spout 112b in the flipped up position, where fluid communication is provided between spout 112b and straw portion 112a, allowing the user to drink.

FIGS. 1C and 1CC illustrates another position, in which spout 112b is flipped even further downward into recess 114, causing the end 116a of spout 112b opposite its dispensing end 116b to flip up. For example, dispensing end 116b may rotate downward into recess 114, towards the bottom thereof. In this position, the opening in end 116a into which flavor tablet 118 is to be inserted may be unoccluded by lid 110, so as to allow the user to insert the tablet. As shown, end 116b may be configured to receive a flavor tablet 118 therein. As seen in the cross-sectional view of FIG. 1BB, when spout 112b is flipped up, and fluid communication is established between spout 112b and straw portion 112a, flavor tablet 118 becomes disposed within the flow path that is established. As water is drawn up through straw portion 112a from chamber 108, it passes around and/or through dissolvable tablet 118, which progressively dissolves as the water is sucked up through spout 112b, and straw portion 112a, providing flavor, vitamins, or other desired adjuvant to the delivered flow of drinking water, which flow may have been filtered immediately prior thereto.

While termed herein a flavor tablet for simplicity, it will be appreciated that the dissolvable tablet 118 may deliver one or more of a wide variety of flavors, vitamins, or other adjuvants to the water being delivered. As such, the term “flavor tablet” is to be broadly construed, including a wide variety of such adjuvants, not necessarily limited to just those that contribute a noticeably different flavor to the water.

In an embodiment, the removable lid 110 may include a release valve 117, e.g., positioned in the bottom of recess 114. Such a valve may aid in equalizing pressure as water is being drawn from chamber 108 through spout 112b, as the user drinks. In other words, air may be allowed to enter into chamber 108 through valve 117 as the level of water within chamber 108 drops. Such release valves will be apparent to those of skill in the art.

The straw portion 112a may extend towards, e.g., all the way, or nearly all the way to the bottom of the container 102, to allow a user to suck all the water in the chamber 108 up through the straw 112, without having to invert and/or tilt the water bottle 100. The straw 112 may include a filter 120 disposed therein, the filter 120 being configured to remove impurities, (e.g., particulates, odors, tastes, chlorine, chloramines, etc.) from the water as it is drawn from the chamber 108 up through an opening 122 at the bottom of the straw, through the filter 120. The filter may be an activated charcoal filter such as those employed in the art to remove such impurities from water. The terms “activated charcoal” and “activated carbon” may be employed interchangeably herein. Such filters are not simply a screen or grating which would remove particles above a given size, but one in which the filtering material is chemically active, capable of removing chlorine, chloramines, volatile organic components, etc. through chemical adsorption of the impurities into active sites of the porous, activated charcoal. In an embodiment, the filter may comprise an ion exchange resin (“IER”), capable of removing heavy metal impurities (e.g., lead, mercury, cadmium, etc.). More than one type of filtration may be provided (e.g., activated charcoal and IER), as desired.

In order to provide a flavor (or vitamin, or other adjuvant) to the filtered water, the flavor tablet 118 is disposed within the straw 112 or spout 112b at a location that is downstream relative to the filter 120, so that water drawn through the straw first passes through the filter 120, and then around or through the flavor tablet 118, flavoring the water drawn therethrough. As shown in FIGS. 1A-1CC, the flavor tablet 118 may advantageously be disposed within straw 112 at a location that is above the water line to which the container 108 may be filled. For example, as will be apparent from FIGS. 1AA and 1BB, particularly when flavor tablet 118 is positioned within spout 112b, the tablet 118 may advantageously be at a location that is above the top of container 102, to prevent water from contacting flavor tablet 118 prematurely, or inadvertently. The flow of water only contacts the tablet 118 when the user suctions the water through end 116b of spout 112b. As seen in FIG. 1AA, when the spout 112b is stowed in recess 114, tablet 118 is also held above any water line to which container 102 may be filled, preventing undesired contact or “soaking” of the tablet within the water. As seen in FIG. 1AA, the tablet may be generally horizontal when spout 112b is flipped down in the stowed position, with no portion of the tablet 118 at a location that is lower than the bottom of the tablet 118 when in the drinking position of FIG. 1BB. Such a “higher up” positioning of tablet 118 when not in use may further aid in preventing unintentional contact between the tablet and the water in container 102 or straw portion 112a.

The straw and/or spout portions may be configured to provide for quick, convenient replacement of the filter 120 when the filter 120 is exhausted (e.g., when the activated charcoal is “full”), as well as quick, convenient replacement of a flavor tablet 118, once a previously installed tablet 118 has dissolved, or when a user desires to otherwise replace one tablet for another. For example, FIGS. 1A-1C and 1AA-1CC show how the spout portion 112b may be rotatable “up and down” within removable lid 110, so as to provide for the positions shown in FIGS. 1B, 1BB and FIG. 1C, 1CC, where FIGS. 1B, 1BB show the typical drinking position of spout 112b, and FIGS. 1C, 1CC show a position where end 116a of spout 112b is flipped upward, putting spout 112b in an inverted orientation. In this orientation, the open end 116a of spout 112b is accessible, at the top of removable lid 110, allowing easy insertion of flavor tablet 118. Once inserted, spout 112b may be rotated back to the position shown in FIG. 1B or that of FIG. 1A.

As shown, the flow channel within spout 112b at end 116a may be flared, so as to exhibit increased height, along at least a portion of the width of the spout. For example, along a center portion of the bottom wall of the spout, the bottom wall may include a rounded depression, forming a finger tab, providing better grabbing access when a user desires to grab and remove a flavor tablet and/or replace it with another. For example, such flaring (e.g., in the form of a depressed finger tab) aids in facilitating easier removal of tablet 118 from end 116a, making it easier for a user to grip an end of tablet 118 if it is desired to remove the tablet, and replace it with another (or to remove what remains of a previous tablet and replace it with another) Such flaring (or a depressed finger tab) may also aid in providing sufficient flow channel cross section area at the interface with the lower straw portion 112a, where portion 112a and spout 112b fluidly communicate with one another when spout 112b is rotated as shown in FIG. 1BB.

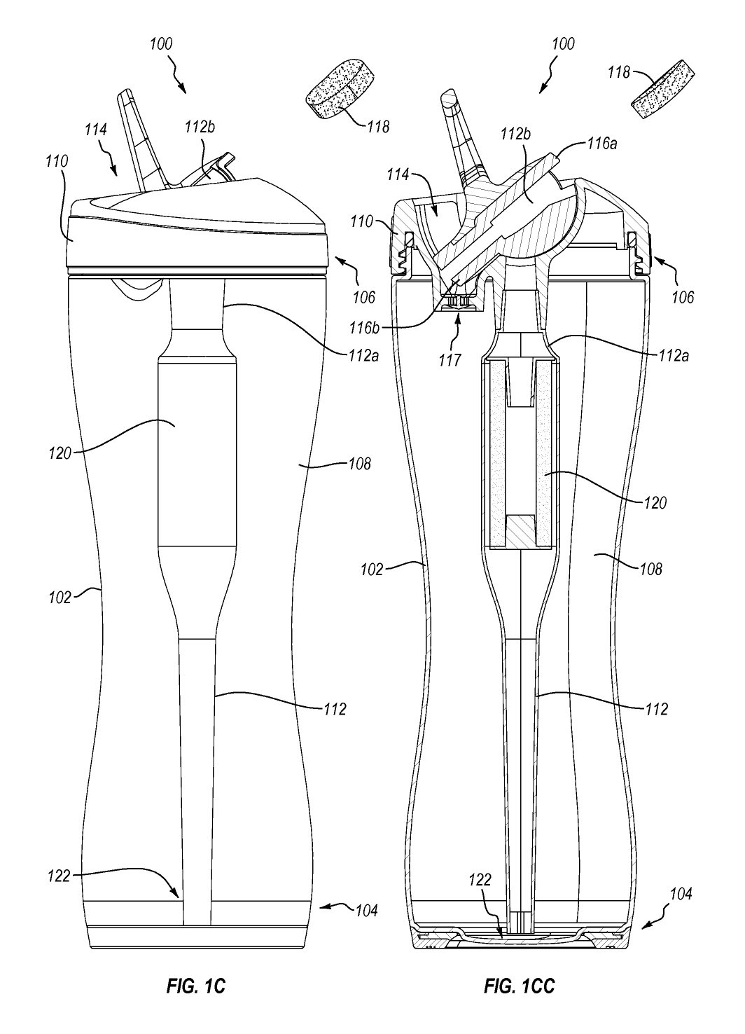

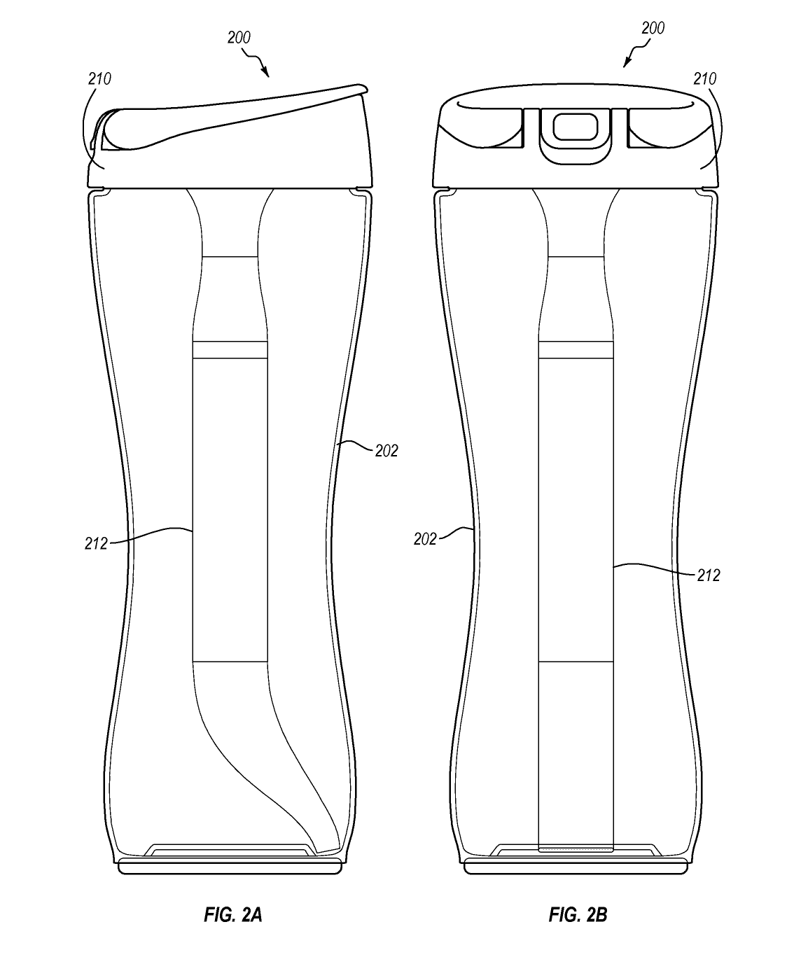

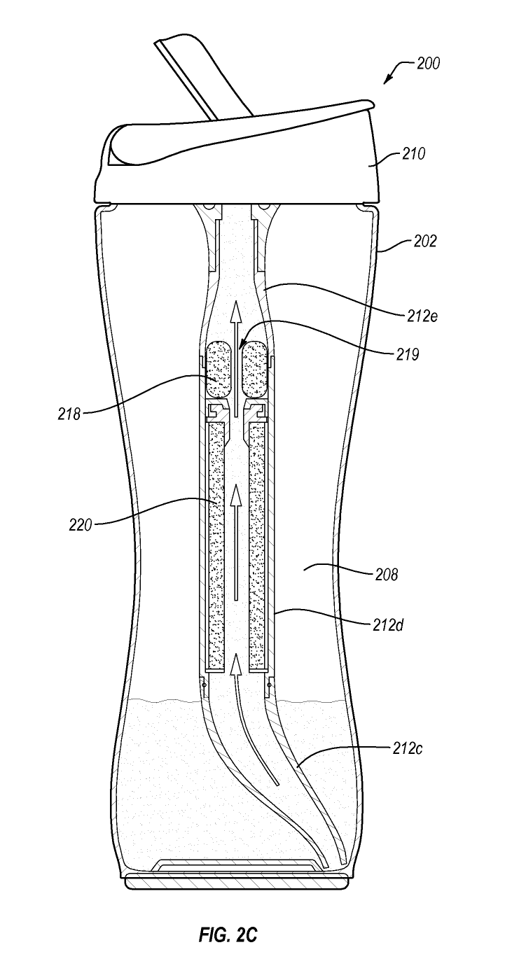

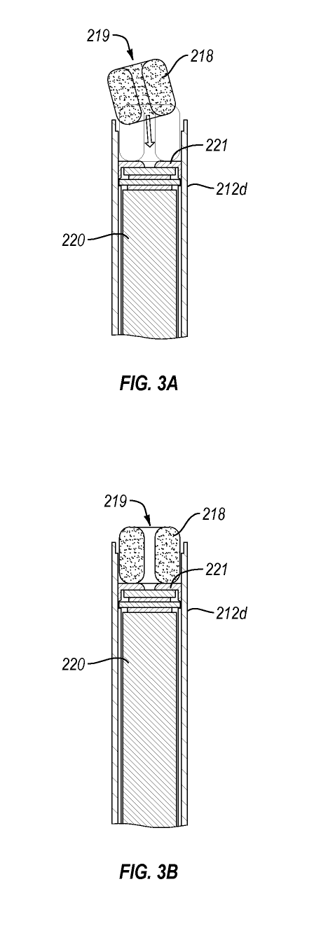

In another embodiment, the tablet and recess in spout 112b for reception of the tablet may be configured so that an end of the tablet protrudes out from the spout end, facilitating gripping and removal of the tablet when needed. An example of a protruding configuration which facilitates removal is shown and described in conjunction with FIGS. 2C-3B. Others will be apparent. The finger tab depression in the spout may be preferred where the tablet is in the spout, in order to provide a good seal between the spout 112b and the straw portion 112a.

In an embodiment, the straw may be easily uncoupleable from the removable lid and/or spout. For example, when it becomes necessary to replace filter 120 (e.g., once the activated carbon therein is full, e.g., after about 30 or about 60 days of typical use, depending on configuration, usage, etc.), one may simply discard the entire straw portion 112a. In another embodiment, the lower straw portion 112a itself may include a plurality of sections (e.g., one of which may include the filter 120). In such an embodiment, the filter portion of the straw portion 112a may be replaced as needed, while the other portions of such a multi-portion straw may be reused.

Another example of a straw configuration including multiple sections therein is shown in the water bottle 200 of FIGS. 2A-2C. The filter 220 may be disposed within one section (e.g., a middle section 212d) of the straw 212, providing a sort of filter cartridge section 212d of the straw 212, which section 212d can be replaced after 60 days or so (e.g., once the activated charcoal is no longer effective to a desired standard). Straw 212 is shown as including sections 212c, 212d, and 212e.

FIGS. 2A-2C also show positioning of the flavor tablet 218 at a location within straw 212 that is below the top of the container. Where such a container is filled to capacity or near capacity, the flavor tablet may reside below the water line. In such an embodiment, it may be desirable to ensure a good water-tight seal is provided between the interior and exterior of the straw. Even where so provided, it may be preferred that the flavor tablet be positioned at a location in the straw or spout above the water line, as even with a good seal, if the container is full or nearly fully, the straw may fill with water simply due to pressure of the water column on the bottom opening of the straw.

The embodiment shown in FIG. 2C shows a break in the straw sections for providing easy access to the flavor tablet when replacing a flavor tablet. FIGS. 3A-3B illustrate insertion and/or removal of the tablet 218. As seen in FIGS. 2C-3B the same section of the straw 212 housing the filter 220 (e.g., middle section 212d) may also house at least a lower portion of the flavor tablet 218 dropped therein, so as to rest against the top of the filter housing 221. Advantageously, a portion of the flavor tablet 218 may extend above the top rim of the filter section 212d of the straw 212, so as to be more easily graspable by a user desiring to remove the tablet 218 (e.g., and replace it with another). Thus, the flavor tablet 218 may be disposed within two sections of the straw during use (i.e., both section 212d and 212e), spanning the interface between the middle section 212d including the filter 220 and the top section 212e (e.g., which may be attached to the removable lid 210, coupled over container 202). Top section 212e may simply press-fit into a receptacle in the underside of removable lid 210, so as to be retained therein during use. It may be pulled therefrom, when desired. Straw portion 112a of bottle 100 may similarly be press fit into the underside of lid 110. While straw portion 112a is shown as pressing into a receptacle in the underside of the lid 110, it will be appreciated that the straw could alternatively into a smaller dimensioned (e.g., diameter) protrusion of the lid 110). In other words, the straw may plug into the “inside” of the lid receptacle, or vice versa.

The configuration shown in FIGS. 2C-3B advantageously positions the flavor tablet 218 so at least a portion thereof extends above the top rim of the straw section 212d housing the filter 220, aiding a user in grasping the tablet 218 for removal and placement.

For example, a user may unscrew or otherwise uncouple the filter section 212d of the straw 212 from the adjacent upper straw section 212e, remove the flavor table 218 (if any of it still remains undissolved), and place another flavor tablet 218 in the top of the filter section 212d of the straw 212, above the filter 220.

Because the flavor tablet 218 (or 118) is disposed downstream from the filter 220 (or 120), the filter will not filter out the flavorant or other adjuvant from the water. This is important, e.g., as if one were to put a flavored drink into the chamber of a water bottle including a filter, the filter would remove some or all of the flavoring components from the water as it is drawn through the filter. Thus, an important feature of at least some embodiments of the present invention is placement of the flavor tablet 218 or 118 at a location that is above, i.e., downstream from the filter 220 or 120, so that the flavorant (or other adjuvant) is added to the water after being filtered.

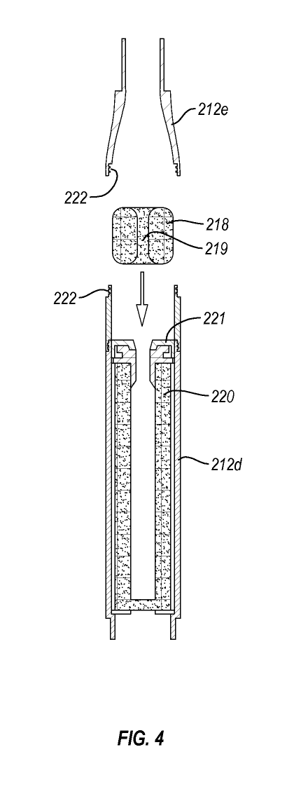

As described above, in an embodiment, the straw may be provided in a plurality of sections which are coupleable to one another. FIG. 4 illustrates a threaded connection mechanism 222 between upper straw section 212e and middle straw section 212d. Alternative connection mechanisms could alternatively be provided (e.g., a snap connection (e.g., a rib and mating groove), a press-fit connection, etc. In an embodiment, a magnetic connection between straw sections may be provided, e.g., a perimeter magnet in one of the straw sections, and another magnet or magnetically attractable material (e.g., iron or nickel containing metal) in the other coupling straw section. Such a mechanism holds the two straw sections together when they are brought in close proximity to one another. In such a magnetically coupled mechanism, no further mechanical coupling (e.g., threads, groove and rib, etc.) need be required. A water-tight seal may be provided between the straw sections coupled together, in any such embodiments (e.g., magnetically coupled or otherwise), to prevent water from leaking into the straw through the coupling. A magnetic coupling mechanism may provide a clean environment to both structures, and provide consistent coupling force between the sections. Such connection mechanisms could also be employed in connecting the top of the straw section (e.g., 112a or 212e) to the underside of the removable lid, if desired.

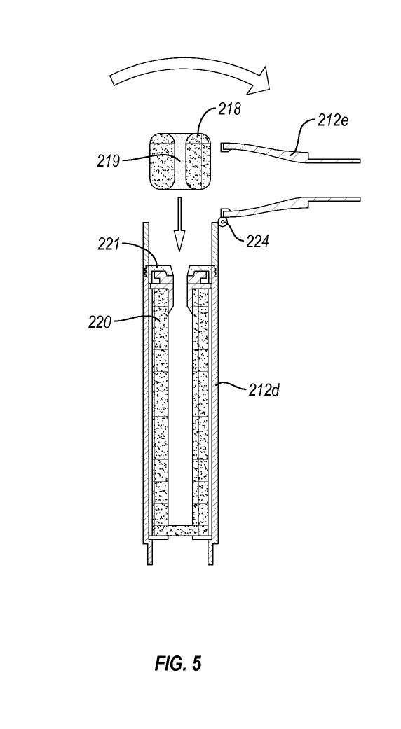

FIG. 5 illustrates another exemplary connection mechanism, e.g., including a hinge 224 between straw sections 212d and 212e. Other suitable connection mechanisms will be apparent to one of skill in the art.

The flavor tablet may have any desired configuration. Various configurations are described herein, and particular configurations are shown in FIGS. 1A-1CC and FIGS. 2C-3B. For example, the tablet 118 of FIGS. 1A-1CC is shown as generally square or rectangular in shape, with rounded corners. The major faces of the tablet 118 are shown with some curvature, with one (e.g., the upper surface) being concave, and the other (e.g., the lower surface) convex, giving the tablet itself some overall curvature to the major faces. The interior of spout 112b at end 116a may be similarly shaped (e.g., generally square or rectangular in cross-section, so as to accommodate tablet 118 therein). Some space may advantageously be present between the interior sidewalls defining spout 112b and the exterior of the tablet, so that water can pass through the channel defined therebetween.

In another embodiment, a channel may be provided within the tablet itself. Tablet 218 is shown as including such an interior flow channel 219. For example, flavor tablet 218 is shown as being generally cylindrical in shape. It may include or at least partially define a flow channel (e.g., vertical) 219 through which the water may flow. In any case, with either tablet, as the water contacts and flows against surfaces of the tablet, the tablet may dissolve, allowing the flavoring components (or other adjuvant components) of the tablet to be entrained or dissolved into the water drawn through the straw and/or spout and drunk by the user.

The embodiment illustrated in FIGS. 2C-3B shows a cylindrical shaped flavor tablet body 218 including a single vertical channel 219 disposed centrally (e.g., aligned with the longitudinal axis of the straw section 212d) through the cylindrical tablet body 218. Other configurations are of course possible. For example, more than one such flow channel could be provided (e.g., two or three channels) through the flavor tablet. The flow channel need not be vertical. In another embodiment, the flow channel may be defined between the inside wall of the straw section or spout, and an outside perimeter or outside diameter of the flavor tablet. The tablet 118 shown in FIGS. 1A-1CC is of this configuration. For example, if the flavor tablet has an outside diameter or perimeter that is less than the inside diameter or width between sidewalls of the straw or spout, a flow channel at the perimeter of the tablet is defined between the tablet and the inside of the straw or spout wall.

In any such case, as water is drawn across the surface of the tablet, the tablet will dissolve, imparting the desired flavor (or whatever adjuvant, be it vitamins, flavor, etc.) to the water drawn through that portion of the straw or spout where the flavor tablet is located. The flavor tablet may be in the form of a solid that is dissolvable in the water flow. Alternatively, gels or other states of the flavorant may possibly be employed. In any case, the flavorant material is dissolved or entrained in the water as it flows over the flavor tablet surface.

It is conceived that a wide variety of flavor tablets could be provided, e.g., separate from the water bottle. For example, the water bottle may advantageously be reusable (e.g., dishwater safe, with easy disassembly of the various parts, the container, the straw, the removable lid, etc. to allow it to be periodically cleaned for reuse). Flavor tablets could be sold or otherwise provided separate from the water bottle, for use therewith, as could the filter section of the straw that may typically need to be replaced periodically. For example, one may be able to purchase a package including a plurality of flavor tablets, providing the same or a variety of different flavors. Any conceivable flavor may be provided by such flavor tablets, e.g., energy drink flavors, soft drinks, fruit flavors, etc.

The tablet may provide a relatively mild infusion of flavor into the water being drunk, rather than a strong, “full” flavored drink. For example, the flavor imparted may be similar to that of adding a slice of lemon, lime, or other fruit to water, giving it a mild, but flavored taste. In addition to flavors, it will be appreciated that other adjuvants may be entrained or dissolved in the water by such a mechanism. For example, energy components (e.g., B vitamins, caffeine, etc.), electrolytes (e.g., sodium, potassium, etc.), vitamins (e.g., vitamin C, etc.), minerals (e.g., zinc, etc.) or nutritional supplements may be provided, as well as or in place of a flavorant. For example, a flavor tablet for prevention or treatment of cold symptoms could include ingredients similar to those found in AIRBORNE and/or NUUN effervescent dissolvable tablets (e.g., dissolvable matrix (e.g., a sugar such as maltodextrin, sodium bicarbonate, potassium bicarbonate, and/or an organic acid such as citric acid), vitamin C, other vitamins (e.g., B, A, etc.), zinc, sodium, potassium, magnesium, calcium, etc.).

As the tablet does not necessarily need to include an ingredient providing a discernable flavor, as described above, the term flavor tablet as used herein is to be construed broadly to include such active components, even if they may not technically provide a discernable flavor. Of course, in an embodiment, where energy, electrolyte, or other components that may not technically provide a discernable flavor are provided, they may be provided in combination with components that would provide a discernable flavor (e.g., fruit flavors, etc.). Other components, e.g., sugar, other sweeteners, etc., as well as a dissolvable matrix material within which the desired flavor components are dispersed may of course be employed. In an embodiment, the flavorant could be a sweetener, such as sugar, sugar alcohol (e.g., xylitol), or other sugar substitute (e.g., providing a sweet flavor).

In an embodiment, the straw may include a diameter or cross-sectional area (whether circular or otherwise) that varies along its length. For example, the diameter or cross-sectional area within the interior of the straw may be relatively lower at location(s) below the filter, so that less suction force is required. The diameter or cross-sectional area of the flow channel at least partially defined by the flavor tablet may similarly vary to affect the suction force required. For example, relatively smaller cross-sectioned flow channels may alter the suction force required. Sufficient area to the flow channel(s) may be provided to provide desired flow characteristics as a user sucks the water from the bottle, through the straw, filter, and through and/or around the dissolvable flavor tablet. The actual values selected may be determined based on the flow characteristics desired. In an embodiment, the flow channel adjacent and/or through the flavor tablet will be narrowed (e.g., smaller cross-sectional area) relative to the flow channel through adjacent portions of the straw and/or spout in which the flavor tablet is disposed.

In an embodiment, the flavor tablet may be configured in size and compositional characteristics so that it provides flavoring (e.g., substantially uniform throughout its life) to the volume of water held by the water bottle. For example, for a 20 ounce water bottle, a single flavor tablet may be configured so that at approximately the same time the 20 ounces of water has been drunk, the flavor tablet has fully dissolved (i.e., it is gone). The same relationship of one flavor tablet consumed per full volume of water bottle may be provided for any given size (e.g., 16 ounces, 24 ounces, 32 ounces, etc.).

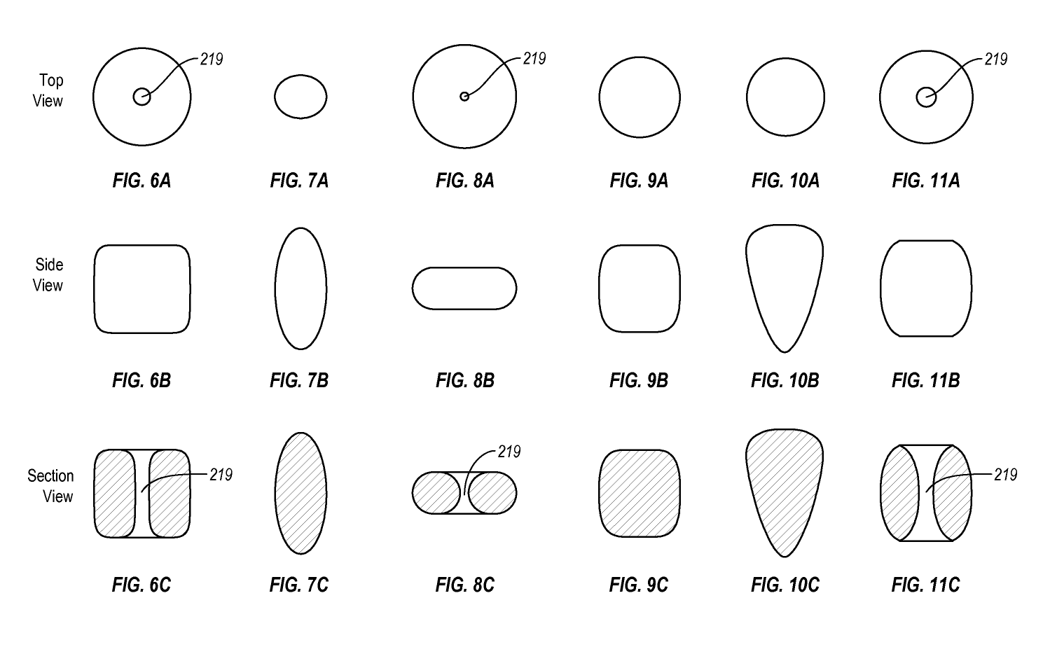

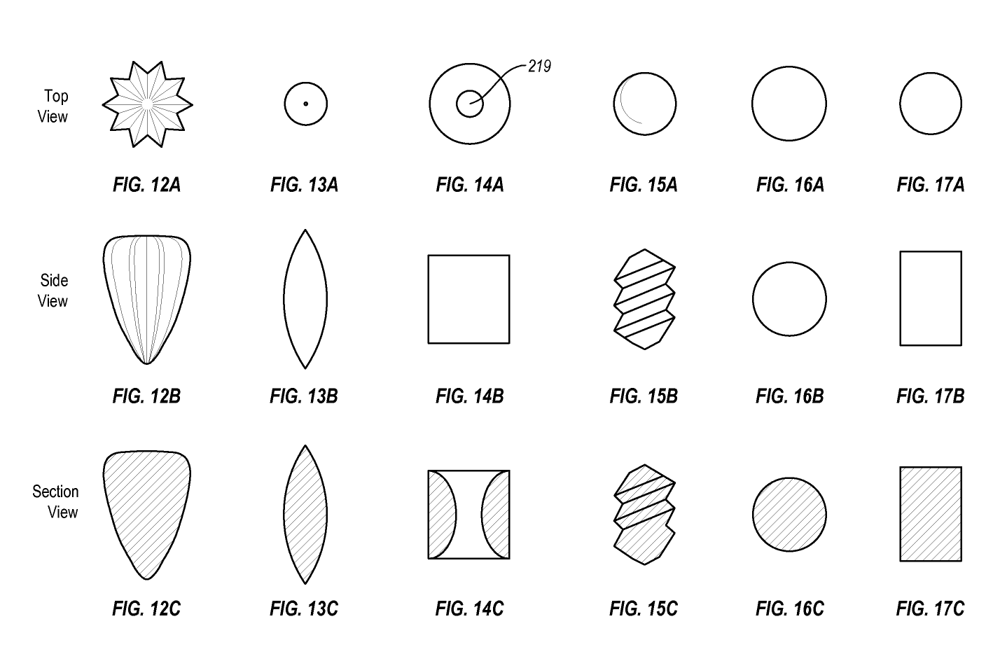

FIGS. 6A-17C illustrate various exemplary flavor tablet shapes and configurations that may be employed. Each of the “A” Figures shows a top view. Each of the “B” Figures shows a side elevation view, and each of the “C” Figures shows a cross-sectional view. Some of the illustrated tablets include an internal flow channel 219. Other of the tablets rely on formation of a perimeter flow channel defined between the exterior side surface of the tablet and the adjacent interior surface of the straw or spout into which the tablet is positioned during use. In either case, suctioned water flow is permitted adjacent to dissolvable surface(s) of the dissolvable flavor tablet, so as to progressively dissolve the components of the flavor tablet, so that they become dissolved or entrained in the suctioned stream of water being drunk by the user sucking on the spout of the straw. FIGS. 6A-6C shows a tablet similar to tablet 218 of FIGS. 2C-3B.

The inventors earlier U.S. patent application Ser. No. 13/662,169 and corresponding PCT application WO2013/063535, disclosing a water bottle with a straw and agitator, are incorporated by reference in their entirety herein. The water bottle described herein may include any of the features described therein.

Although principally described in the context of a water bottle including a filter within the straw (or spout), it will be appreciated that the described flavor tablets could be employed to flavor water drawn through the straw, where a filter is not present. For example, the straw of U.S. patent application Ser. No. 13/662,169 could be attached to the underside of the removable lid 110 (“the flavoring lid or cap”). Similarly, the removable lid of U.S. patent application Ser. No. 13/662,169 could be attached over the container 102 or 202 and straw section 112a or 212 as disclosed herein, for use. Any other combination of removable lids, straws, containers, etc. from U.S. patent application Ser. No. 13/662,169 and the present embodiments could be provided, where the components are compatible and attachable to one another.

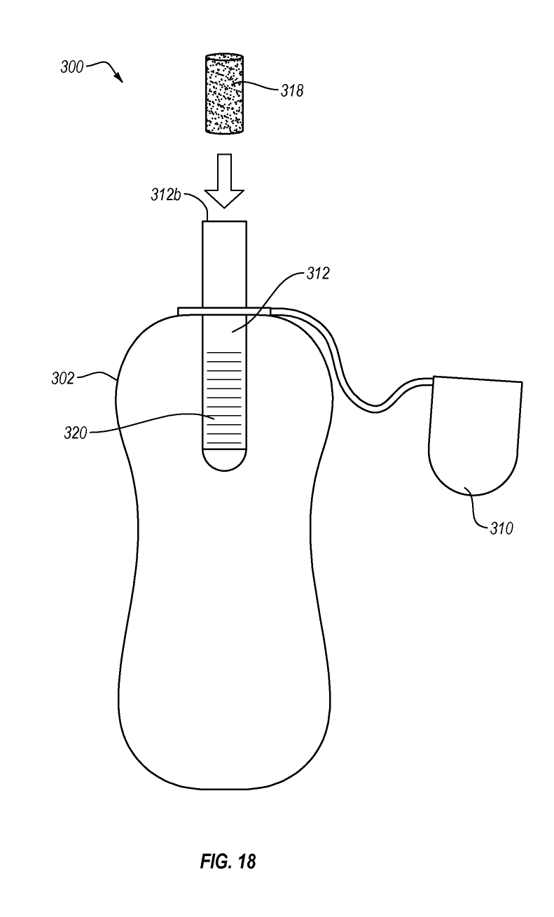

Various other water bottle configurations will also be apparent to one of skill in the art in light of the present disclosure. For example, a flavor tablet could be incorporated into a squeeze bottle type water bottle that may not necessarily include a long straw, but which is intended to be inverted, and the water drunk from a spout over the top of the water bottle. FIG. 18 illustrates such an exemplary embodiment of a water bottle 300 including a container 302 and removable lid 310. If a straw is present, it may be shortened (e.g., not reaching near the bottom of container 302), as water drunk from bottle 300 may be supplied by inverting the water bottle, and squeezing the sides of container 302. For example, the container 302 may be formed of a flexible material (e.g., flexible plastic or rubber-like plastic) that allows the user to squeeze the sides, forcing water to enter into straw 312, and exit through spout 312b. In an embodiment, a filter 320 may optionally be provided within the straw or spout. Downstream from any included filter a flavor tablet (e.g., 318) may be provided. The flavor tablet may be inserted into the spout and/or straw at any suitable location downstream from a filter, if a filter is present. Any of the structures and configurations described herein for housing the flavor tablet may be employed in such a squeezable water bottle. Thus, it will be apparent that a straw as shown in FIGS. 1A-2C may not necessarily be provided.

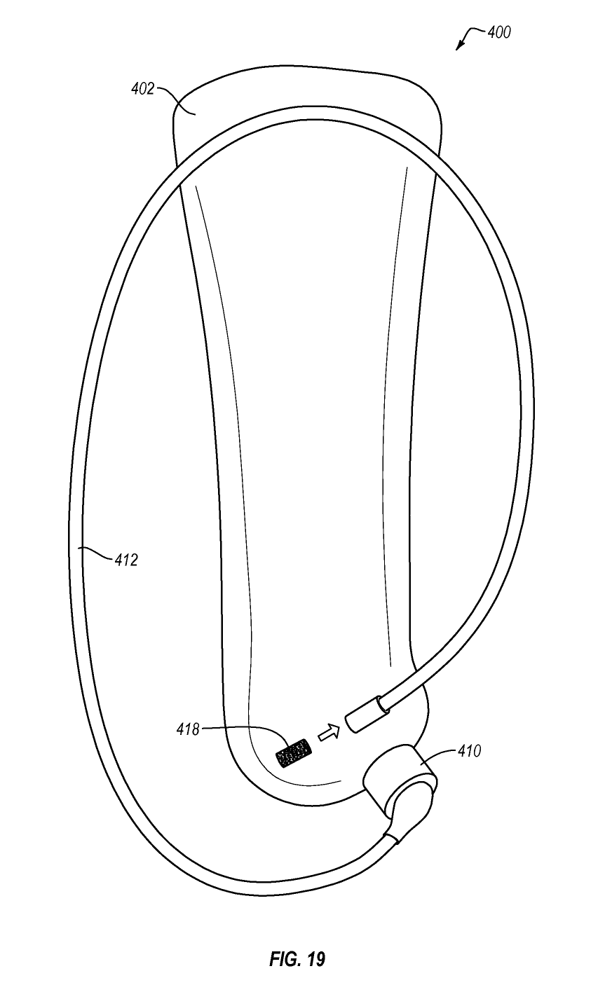

Another embodiment 400 is shown in FIG. 19, in which the water bottle container 402 may be in the form of a flexible bag or bladder (e.g., similar to those provided by CAMELBAK or PLATYPUS). A removable lid 410 may be provided over an opening in the container 402. A straw, e.g., in the form of a tube 412 may be provided attached to the lid 410. As will be apparent from this embodiment, in at least some embodiments of the present invention, where a straw is present, the straw 412 need not be disposed within the container, but may be exterior the container 402. In an embodiment, a portion of the straw may be within the container, and another portion exterior the container. Optionally, a filter may be disposed within the straw (e.g., tube) 412. A flavor tablet 418 may also be disposed within the straw (e.g., tube) 412 at a location that is downstream from any included filter, allowing the user to flavor water as it is pulled (e.g., suctioned) through the tube, before it exits the end of the tube into the user's mouth.

In addition, while described principally in the context of a flavor tablet, it will be appreciated that in another embodiment, the flavor material could be housed within a cartridge or “cage” that is inserted within the straw or spout portion thereof, allowing the water to be drawn through the cartridge, contacting and dissolving or otherwise entraining the flavor materials into the water stream drawn through the straw. Such flavor materials could be in the form of granules trapped within the cartridge or cage, or the above described monolithic flavor tablet solids or gels. Monolithic, non-granular forms for the flavor tablet may be preferable, as they are less messy, easier to insert and remove, etc.

By “substantially fills” it is meant that a cross-sectional area across the interior of the straw where the flavor tablet is positioned is filled, but for one or more channels provided through the flavor tablet or between the flavor tablet and an interior wall of the straw, so that water drawn into the straw is pulled through the filter, and then around or through the flavor tablet, flavoring the water drawn therethrough. The channels may occupy less than 50%, less than 40%, less than 30%, less than 25%, less than 20%, less than 15%, or less than 10% of the entire cross-section of the spout or straw where the tablet is disposed.

Numbers, percentages, or other values stated herein are intended to include that value, and also other values that are about or approximately the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing process, and may include values that are within 25%, within 10%, within 5%, within 1%, etc. of a stated value. Furthermore, the terms “substantially”, “similarly”, “about” or “approximately” as used herein represents an amount or state close to the stated amount or state that still performs a desired function or achieves a desired result. For example, the term “substantially” “about” or “approximately” may refer to an amount that is within 25% of, within 10% of, within 5% of, or within 1% of, a stated amount or value.

Ranges between any values disclosed herein are contemplated and within the scope of the present disclosure (e.g., a range defined between any two values given as exemplary for any given parameter).

As used in this specification and the appended claims, the singular forms “a,” “an” and “the” include plural referents unless the context clearly dictates otherwise.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A water bottle comprising:
a container having a closed end and open end, the container defining a chamber therein for containing water;
a removable lid that is selectively coupleable over the open end of the container;
a straw disposed through the removable lid, or attached to the removable lid;
a filter disposed within the straw, the filter removing impurities from water as it is drawn from the chamber through an opening into the straw, through the filter; and
a flavor tablet disposed within the straw or a spout selectively in fluid communication with the straw, the flavor tablet being disposed at a location that is downstream from the filter, so that water drawn into the straw is pulled through the filter, and then around or through the flavor tablet, flavoring the water drawn therethrough.

2. A water bottle as recited in claim 1, wherein:
the closed end and open end of the container comprises a closed bottom and open top, respectively;
the removable lid is selectively coupleable over the open top of the container;
the straw is disposed through the removable lid, or attached to an underside of the removable lid, and the straw extends towards the closed bottom of the container;
the filter disposed within the straw removes impurities from water as it is drawn from the chamber up through the opening into the straw, which opening is disposed at a bottom of the straw; and
the flavor tablet is disposed at a location that is above the filter.

3. A water bottle as recited in claim 2, wherein the water bottle comprises a spout disposed within or above the removable lid, the straw being attached to an underside of the removable lid, the spout selectively being in fluid communication with the straw attached to the underside of the removable lid.

4. A water bottle as recited in claim 3, wherein the flavor tablet is disposed within the spout.

5. A water bottle as recited in claim 2, wherein the flavor tablet is disposed in the straw or spout at a location that is above a water line to which the container can be filled.

6. A water bottle as recited in claim 5, wherein the water bottle comprises a spout disposed within or above the removable lid, and wherein the straw extends below the removable lid, wherein the flavor tablet is disposed within the spout, above the container.

7. A water bottle as recited in claim 2, wherein the straw comprises a plurality of sections that are uncoupleable from one another, the filter being disposed within a section of the straw, such that a user may uncouple the section including the filter and replace it with a replacement section including a new filter once the filter is exhausted.

8. A water bottle as recited in claim 7, wherein the straw comprises three sections that are uncoupleable from one another, the filter being disposed within a middle section of the straw.

9. A water bottle as recited in claim 8, wherein the flavor tablet is located between the middle section and an upper section of the straw, resting on the top of the filter, with a portion of the flavor tablet extending above a top end of the middle section of the straw so that a user may uncouple the middle section of the straw from the remainder of the straw, remove the flavor tablet, and replace the removed flavor tablet with another flavor tablet.

10. A water bottle as recited in claim 9, wherein the flavor tablet is cylindrical in shape, and includes a hollow central flow channel aligned with a longitudinal axis of the straw when the flavor tablet is disposed within the straw.

11. A water bottle as recited in claim 2, wherein the flavor tablet is generally rectangular in shape, and at least partially defines a perimeter flow channel between an exterior surface of the flavor tablet and an interior surface of the straw or spout when the flavor tablet is inserted therein.

12. A water bottle as recited in claim 2, wherein the flavor tablet is cylindrical in shape, and includes a hollow central flow channel aligned with a longitudinal axis of the straw when the flavor tablet is disposed within the straw.

13. A water bottle as recited in claim 2, wherein the flavor tablet is formed of a dissolvable solid material that dissolves in the water drawn through the straw or spout.

14. A water bottle as recited in claim 2, wherein the filter is an activated charcoal filter.

15. A method of flavoring water in a water bottle, the method comprising:
providing a water bottle comprising:
a container having a closed end and open end, the container defining a chamber therein for containing water;
a removable lid that is selectively coupleable over the open end of the container;
a straw disposed through the removable lid, or attached to the removable lid;
a filter disposed within the straw, the filter removing impurities from water as it is drawn from the chamber through an opening within the straw, through the filter; and
a flavor tablet disposed within the straw or a spout selectively in fluid communication with the straw, the flavor tablet being disposed at a location that is downstream from the filter, so that water drawn into the straw is pulled through the filter, and then around or through the flavor tablet, flavoring the water drawn therethrough; and
drawing water contained in the chamber through the straw, so that the water is drawn through the filter and then around or through the flavor tablet, flavoring the water.

16. A flavor tablet for disposition in a straw or spout of a water bottle, for use in flavoring water within a water bottle comprising a container having a closed end and open end, the container defining a chamber therein for containing water, a removable lid that is selectively coupleable over the open end of the container, a straw disposed through the removable lid, or attached to the removable lid, and a filter disposed within the straw, the filter removing impurities from water as it is drawn from the chamber through an opening within the straw, through the filter during use, the flavor tablet comprising:
a dissolvable tablet body which at least partially defines one or more hollow flow channels, the tablet body being formed of a dissolvable solid material that dissolves as water is drawn through the one or more hollow flow channels when the flavor tablet is disposed within the straw or spout of the water bottle at a location that is downstream from the filter, so that water drawn into the straw is pulled through the filter, and then around or through the flavor tablet, flavoring the water drawn therethrough.

17. A flavor tablet as recited in claim 16, wherein the tablet body is generally rectangular or cylindrical.

18. A flavor tablet as recited in claim 16, wherein at least one of the one or more hollow flow channels are formed between a perimeter of the tablet body and an interior surface of the straw or spout of the water bottle.

19. A flavor tablet as recited in claim 16, wherein the one or more hollow flow channels are formed entirely within the tablet body.

20. A water bottle comprising:
a container having a closed bottom and open top, the container defining a chamber therein for containing water;
a removable lid that is selectively coupleable over the open top of the container;
a straw disposed through the removable lid, or attached to an underside of the removable lid, the straw extending towards the closed bottom of the container;
a filter disposed within the straw, the filter removing impurities from water as it is drawn from the chamber up through an opening at a bottom of the straw, through the filter; and
a single dissolvable flavor tablet disposed within the straw or a spout of the water bottle at a location that is downstream from the filter, the flavor tablet having a shape that substantially fills a cross-sectional area across the interior of the straw but for one or more channels provided through the flavor tablet or between the flavor tablet and an interior wall of the straw or spout in which the flavor tablet is disposed, so that water drawn into the straw is pulled through the filter, and then around or through the flavor tablet, flavoring the water drawn therethrough.
